(19) United States
(12) Patent Application Publication
(10) Pub. No.: US 2004/0199874 A1
(43) Pub. Date: Oct. 7, 2004

(54) Method and apparatus to display paper-based documents on the internet

(76) Inventor: Stephen C. Larson, Clifton Springs, NY (US)

Correspondence Address: STEPHEN C. LARSON, 17 PLEASANT STREET, CLIFTON SPRINGS, NY, 14432, US

(21) Appl. No.: 10/404,499

(22) Filed: Apr. 1, 2003

(51) Int. Cl. G06F 17/21

(52) U.S. Cl. 715/517

(57) ABSTRACT

An on-line publishing system is set forth that causes search engines to direct Internet users to a digital image replica of a paper-based publication as a result of a search of using keywords, said keywords appearing to users only in the digital image replica of a paper-based publication.

### BACKGROUND OF THE INVENTION

Publication of magazines, newspapers, pamphlets, coupons, etc., using paper has been the preferred means for communication of written materials for decades. The processes and machinery needed for preparation and printing of these materials is available nearly everywhere and continues to be more effective and more popular than alternative communication means such as publication using the Internet.

More and more, businesses that distribute paper-based publications are adding Internet based publications of selected portions of their paper-based publications. The processes involved with converting the format of the paper-based publication to an Internet-based publication adds costs due the fact that the format of the paper based publications most often must be changed in order to facilitate for the smaller display size of the typical computer screen and to compensate for less addressable resolution. For example the typical computer screen has a resolution of 70-90 dots per inch while a paper-based publications often have resolutions from 200-600 dots per inch. Facilitating for these differences in display often incurs prohibitive labor costs and less than satisfying appearance as the paper-based publication has much more resolution available encouraging greater creativity.

One way that overcomes the need for reformatting the paper-based publication is by saving the copy associated with the paper-based publication using the common art “PDF” format. This format has gained significant acceptance from users and from authors. Moreover, the “PDF” format has gained significant acceptance by search engine businesses and organizations. That is, search engine concerns have recognized the popularity and importance of the “PDF” format by including the contents of “PDF” formatted files in their searching (spidering) process and by providing pointers directing users to the pages containing “PDF” download links in response to a user searching using keywords associated with the “PDF” file.

There are significant problems with the “PDF” approach to preserving the paper-based appearance of a document available on the Internet. One is that a plug-in must be installed into the Internet browser. Users of the Internet must regularly be bothered by additional updates and extra overhead. Next is that the entire paper-based document must be downloaded in order to view it. If a “PDF” document is 1000 pages and one page contains items that have triggered the search item of interest, the user must find the page with minimal assistance from standard searching methods, yielding a cumbersome way to obtain information. Additionally, within an individual page of a PDF rendered newspaper there are problems navigating within a page the page because left and right scrolling functions often needed and further, when stories are continued on a different page generally there is no hyperlink connection.

To cut down on PDF file sizes other page-to-page navigation methods that break the newspaper into pages are generally unacceptable as they require the reader to know which page they want. The Adobe PDF viewer attempts to minimize the content actually loaded for large files but the load time still is long when compared to HTML.

On the surface, it may appear that there is an easy way to overcome these limitations. One simple way would be to provide instructions to a web browser to display a digital image replica of the paper-based document. One could put text on the same pages that refer to the content of the image replica in the background and display the text using the same color as the page background so that the page maintains its esthetics. The problem with this technique, however, is that search engines may have learned to ignore text displayed in this fashion (or alternatively, penalize web sites using this technique) because historically users practiced this technique to lure people to their websites despite the fact that the actual displayed content was quite different than the hidden text.

Another ostensibly easy way would be to display the text in a human readable form in addition to the digital image replica. Practicing this technique does provide the search engine veracity to the page. The problem with this technique is that esthetically the page is inadequate for a professional publishing system that will continue to attract customers.

There is a need, therefore, for a method to display paper-based documents using paper-based formatting on the Internet that allows search engines to more directly point the user to the content of interest while eliminating the need for a “plug-in” based display technique.

### SUMMARY OF THE INVENTION

The present invention is directed at overcoming the problems set forth above. In particular, the present invention provides a solution to the problem of displaying a digital image replica of a paper-based publication while not requiring the appearance of html formatted text on the same page while further causing search engines to digest hidden text with much greater veracity than available in the prior art. Functionwise, a paper document publisher creates a document for printing. Before printing, the paper document publisher saves the creation as a file for archiving and printing sent to the on-line publisher. The on-line publisher reads this file and extracts text and formatting information and renders a replica of the paper-based publication as a digital image and saves the digital image and the text information to a storage device. Once the digital image and the text information are available, they are formatted for on-line publication using html. Specifically, the text and digital image are saved to a web content server that provides browser-readable code representing a web page; wherein the code first instructs the browser to create a frame within the browser that in the preferred embodiment occupies the entire browser. The browser is also given a link to a second page to be displayed that contains an instruction to display a digital image replica of a paper-based publication. The extracted text is placed in the web page source code within a NOFRAMES tag that is seen only by the search engines.

### BRIEF DESCRIPTION OF THE DRAWINGS

FIG. 1 shows a diagram representing the relationships between the paper document publisher, the on-line publisher, the search engine and users.

FIG. 2 depicts an expanded view of the paper-based document publisher.

FIG. 3 depicts the basic processes performed by the on-line publisher.

FIG. 4 depicts an exemplary paper-based document replica produced by formatting using data in the file.

FIG. 5 represents an expanded view of the production of a text and image file.

FIG. 6 depicts a simple html file that will be used by the search engine to characterize the image file.

FIG. 7 depicts the web page source code containing the instruction to display the paper-based image replica.

### DETAILED DESCRIPTION OF THE INVENTION

The present invention relates to a method and apparatus to display paper-based documents using paper-based formatting on the Internet that causes search engines to point the user to a replica of the paper-based formatted document while eliminating the need for a plug-in to a browser.

The term paper-based document is intended to refer to any paper-based article. For example, a paper-based document could be a newspaper, a magazine, a coupon, an advertisement or a book. Other examples of paper-based articles that benefit from this invention are legal notifications, summons and warrants, employment ads, company benefit manuals, seed catalogues, real estate booklets and tractor repair manuals.

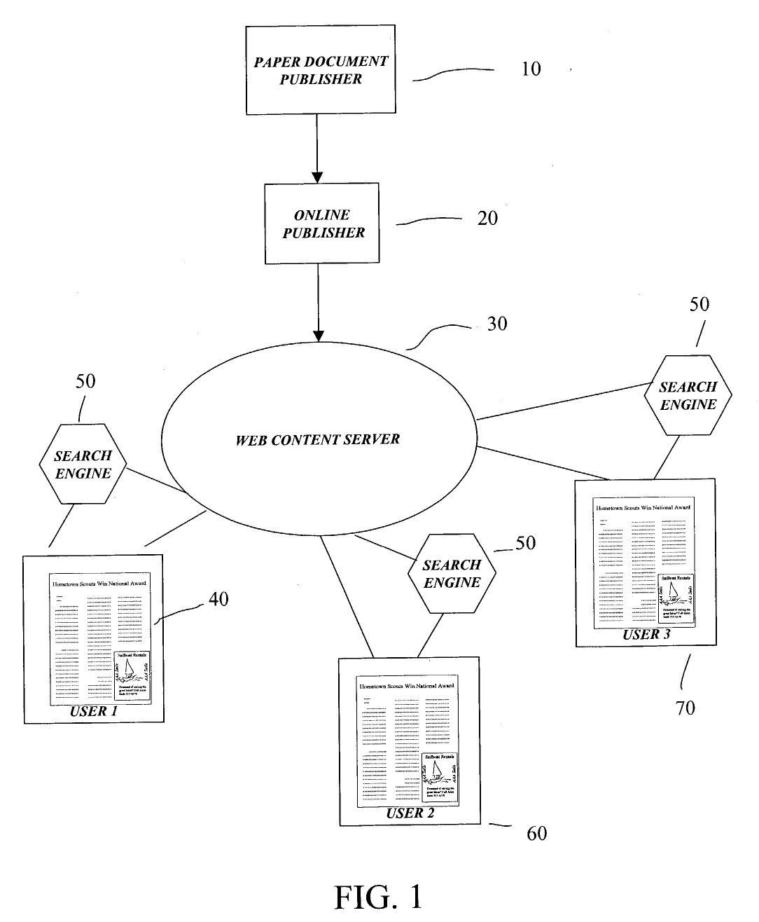

FIG. 1 depicts the broad relationships between the paper document publisher 10, the on-line publisher 20, the web server 30, the search engine 50 and users, 40, 60 and 80. Each of these elements will be expanded below. The paper document publisher creates a document for printing. The creation process is performed on a computer based editing tool such as Quark Xpress®. Before printing, the paper document publisher saves the creation as a file for archiving and printing. This file is also sent via email to the on-line publisher 20. The on-line publisher reads this file and extracts text and formatting information and renders a replica of the paper-based publication as a digital image and saves the digital image and the text information to a storage device. Once the digital image and the text information are available, they are formatted for on-line publication using html. Specifically, the text and digital image are saved a web content server 30 that provides browser-readable code representing a web page; wherein the code first instructs the browser to create a frame within the browser that in the preferred embodiment occupies the entire browser. The browser is also given a link to a second page to be displayed within the frame. The second page provides an instruction to display a digital image replica of a paper-based publication. The initial page also contains the text that was extracted within the NOFRAMES tag that can be seen generally only by the search engines.

After publication on the server, a search engine 50 crawls across the web site and discovers the html file containing the aforementioned text and replica image. The search engine digests the text data and indexes this text information for use by users. Examples of search engines are Google, Yahoo, Excite, etc., and are generally well known by any Internet user. When users 40, 60 and 80 use said search engine by keying in text related to the text contained on the web sever, the search engine makes available a pointer to the URL containing the web page. Because of the fact that the html first instructs the browser to display a frame that occupies the entire browser window then, the browser never shows the text as html formatted text, only the digital image replica of the paper-based document is displayed. This is an unexpected result because search engine companies and organizations have gone to great lengths to ensure that the text in html files are actually representative of the text displayed to the users. Search engines are generally designed to digest information that relates to the actual content displayed, not hidden information used to fool the search engine into directing a user to the web page. This allows the search algorithms to provide to the users a more satisfying experience when on the web.

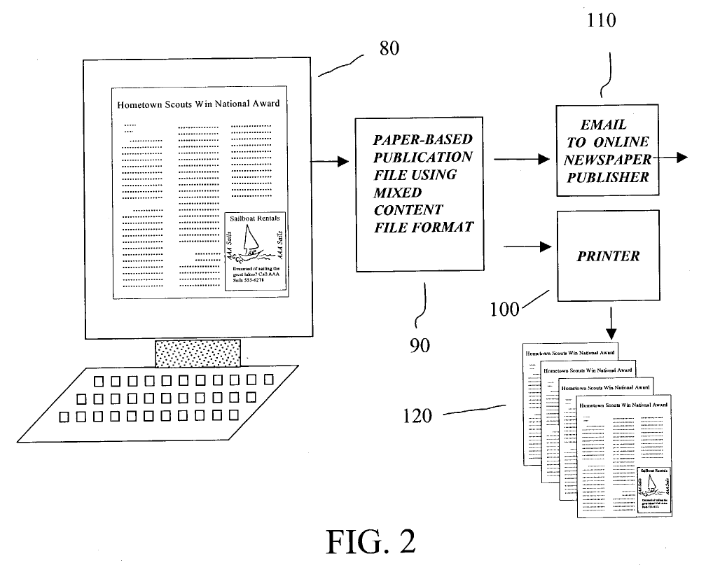

FIG. 2 depicts an expanded view of the paper-based document publisher. The paper-based publisher edits a publication 80 for printing. An important aspect of the invention is that the paper-based publisher need only edit a publication for printing. Once the layout is finished it saved as a file 90. This computer file contains formatting information that is understood by printers so that the formatting designed using the computer is preserved by the printer when the file is sent to the printer for printing. Examples of the preferred and commercially maintained formats that provide such formatting language are: Adobe Post-Script®, Adobe PDF®, Adobe PageMaker®, Adobe Indesign® and QuarkXpress®. These formats are well known within the art of printing and publishing. This file can be sent to a printer 100 to produce a paper-based publication 120 and is also emailed 110 to the online publisher 20. For most online publishers, emailing 110 is the most convenient means for transmission of the file data. Another, less preferred option is to use FTP (File Transport Protocol) or to send a magnetic or optical storage disk to the online publisher via mail containing the file data.

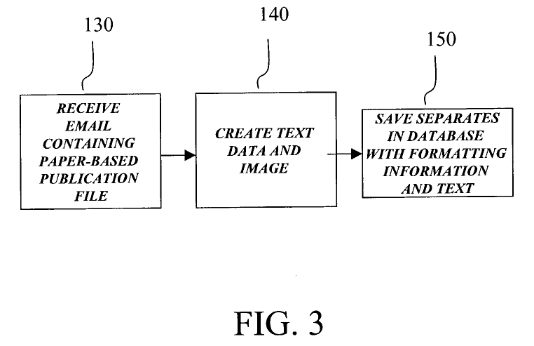

FIG. 3 depicts the basic processes performed by the on-line publisher. The file is received via email 130. Next the on-line publisher must produce two new files 140, one containing the text in the file and an image file, preferably a JPEG or GIF file that is a replica of the paper-based publication and save these files to a storage medium 150.

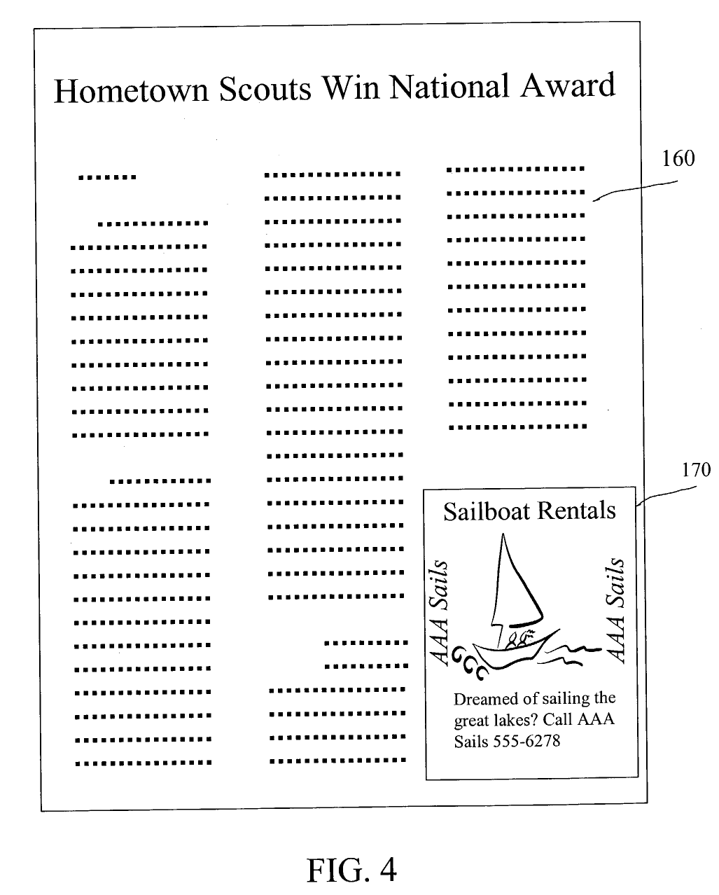

As discussed above, the contents of the file provide formatting instructions and text data to render a paper-based document replica. An exemplary paper-based document replica produced by formatting using data in the file is depicted in FIG. 4. Notice that the article captioned “Hometown Scouts Win National Award” 160 can be intuitively distinguished as separate from the article captioned “Sailboat Rentals” 170. These articles can optionally be separated and published on separate on-line or web pages by first opening the file using the program used to create the file.

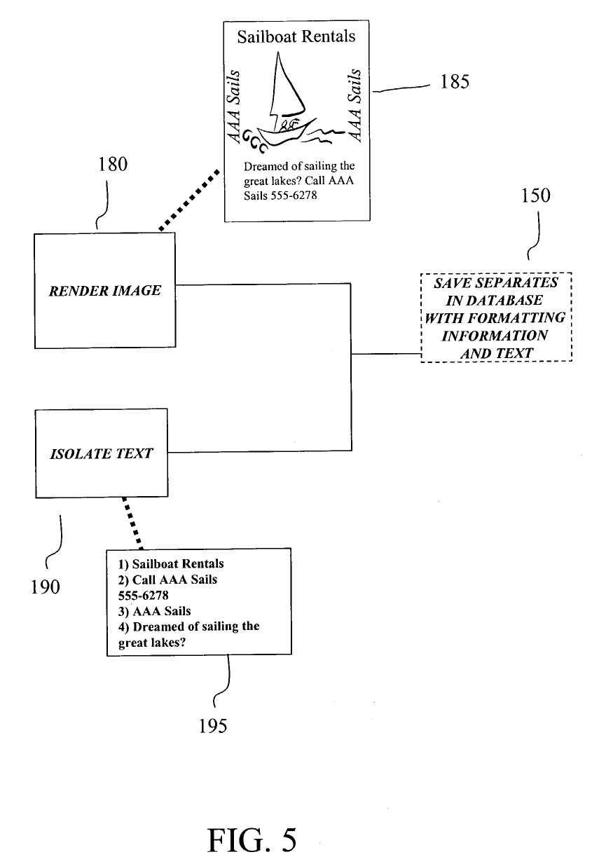

For the sake of clarity, assume it is of interest to publish the article captioned “Sailboat Rentals” 170. Refer now to FIG. 5. FIG. 5 represents an expanded view of step 140, the production of a text and image file. If the file received from the paper-based document publisher is a PDF® file, then Adobe Acrobat® may be used to render 180 or view the image 185. Once the image is in view of an operator, the operator can intuitively distinguish the articles by using the captions, titles or layout as delimiters of the articles. The image associated with the article can be cropped and saved to a storage medium 150 for later conversion to GIF or JPEG. Many programs are available and well known in the art that can perform cropping and file conversion, for example, Adobe Photoshop®.

Next the operator reads the file using a text editor and searches for the caption 190. Once the caption is found the operator copies the text 195 to a text file on storage medium 150 for use later for publication on the web server. This article separation process can be repeated for each article appearing on a page.

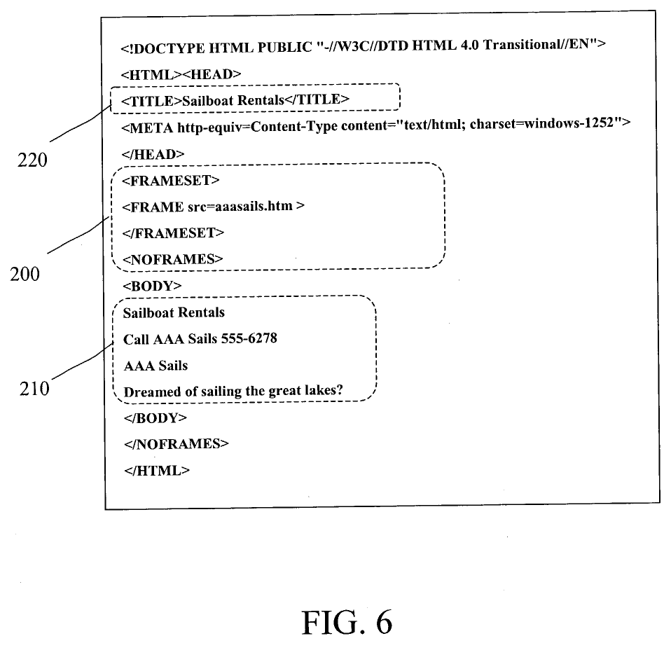

Once the text data has been extracted from the file and the paper-based image replica has been rendered as a digital image such as a JPEG or GIF file, the remaining tasks are now easily implemented. Referring to FIG. 1, the next step is to publish the data distilled thus far on the web content server 30. FIG. 6 depicts a simple html file that will be used by the search engine 50 to extract the text content that will be used to direct the users 40, 60 and 70 to the image file 185 after entering search items relating to the text 195. To those skilled in the art of web page design, the code provided in the figure is exceedingly simple. The first line of the code is not used by the users browser or by the search engine and represents housekeeping information for the benefit of the web designer only. The second line of code provides the browser with instructions that html code is to follow. The third line of code is the title section 220. The specific code “<TITLE>Sailboat Rentals</TITLE>” signifies that the title of the page is “Sailboat Rentals”. As an option, the first few words of text, in the article 170 is placed in this section.

Code section 200 produces the unexpected result of associating hidden text with a digital image. For the sake of clarity code section 200 is replicated below:

<FRAMESET>
<FRAME src=aaasails.htm>
</FRAMESET>
<NOFRAMES>

The html instruction “<FRAMESET>” instructs the browser to produce a frame for content that will appear later. The frame is described in the file aaasails.htm as shown on the second line above. The html instruction “</FRAMESET>” tells the browser that the frame has completed the description of the single frame by virtue of the forward slash appearing before the word FRAMESET. The browser now uses the content provided in aaasails.htm to produce the frame. This will be discussed in greater detail below. The next line, <NOFRAMES> instructs the browser that does not support frames to display a default html instruction set. In FIG. 6., the next line of code is the <BODY> statement. This statement signifies to the browser that does not support frames that the default content follows. In the preferred embodiment the text 195 is placed in the body section 210. It should be noted that the inventor has experimented with formatting the text using differing colors and using varying font characteristics and has concluded that formatting does not appear to affect the veracity of the text to popular search engines. Therefore, transferring the text without formatting to the body section is preferred due to the simplicity of the operation.

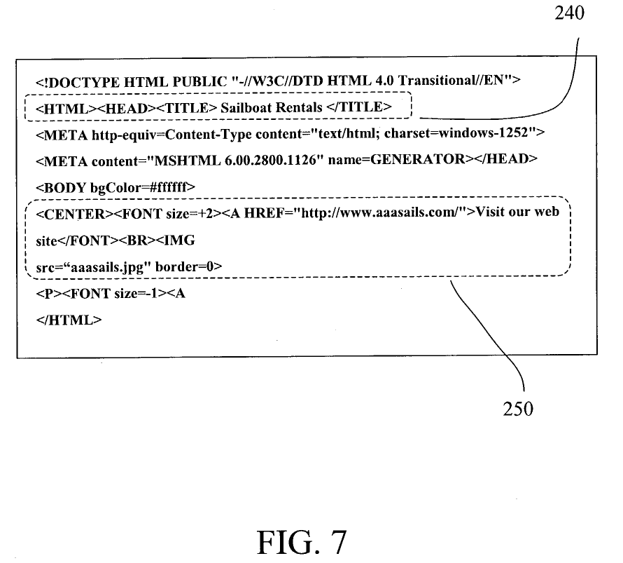

The web page source code containing the instruction to display the paper-based image replica is depicted in FIG. 7. Those skilled in the art of webpage design can easily interpret this code. Code section 240 contains text that is associated with the paper-based image replica and is not required to practice the invention. It is included herein to demonstrate that selected elements of the text data associated with the paper-based image replica can be displayed in a way that does not interrupt the professional appearance that the invention provide. Code section 250 has the primary function of displaying the image 185 as the JPEG file, “aaasailsjpg”, and secondarily provides a hyperlink to another site. The display of the image is the key component of the present invention because this is what the user sees after keying in combinations of the keywords 210. The hyperlink is not necessary to practice the invention and is provided solely to demonstrate a professional aspect that has utility for the implementer and user of the invention.

It is, therefore, apparent that there has been provided, in accordance with the present invention, a method and an apparatus to display paper-based documents on the Internet. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

Parts

10 Paper Document Publisher

20 On-line Publisher

30 Web Server

40 User

50 Search Engine

60 User

70 User

80 Publication

90 File containing publication

100 Printer

110 Emailing step

120 Paper-based publication

130 Receive email step

140 Create text and image step

150 Save text and image to storage medium step

160 Article

170 Article

180 Render image

185 Image

190 Caption

195 Copy text

200 Code section

210 Body section

220 Title section

240 Code section

250 Code section

I claim:

1. An on-line publishing system that causes search engines to direct users to a digital image replica of a paper-based publication as a result of a search of using keywords, said keywords appearing to users only in the digital image replica of a paper-based publication, comprising:
a) means for receiving a paper-based publication file whose file contents contain formatting information representative of the formatting of the paper version of the publication and containing associated text;
b) a computer program that creates a digital image replica of a paper-based publication using the formatting information of the paper-based publication file and the associated text and;
c) a web content server providing browser-readable code representing a web page, wherein the code instructs the browser to create a full page frame within the browser and next to display a page within the frame defined by a link to a second page containing a digital image replica of a paper-based publication and third provides text relating to the keywords describing the paper-based publication within a NOFRAMES tag.

2. The on-line publishing system of claim 1 wherein the paper-based publication is a newspaper.

3. The on-line publishing system of claim 2 wherein the digital image replica of a paper-based publication is a newspaper display ad.

4. The on-line publishing system of claim 1 wherein the paper-based publication is a magazine.

5. The on-line publishing system of claim 4 wherein the digital image replica of a paper-based publication is a magazine display ad.

6. The on-line publishing system of claim 1 wherein the paper-based publication file is in pdf format.

7. The on-line publishing system of claim 1 wherein the paper-based publication file is in Quark Xpress format.

8. The on-line publishing system of claim 1 wherein the paper-based publication file is in Adobe PageMaker format.

9. The on-line publishing system of claim 1 wherein the paper-based publication file is in Indesign format.
